(19) United States
(12) Patent Application Publication
(10) Pub. No.: US 2024/0428767 A1
(43) Pub. Date: Dec. 26, 2024

(54) MUSICAL SOUND PROCESSING APPARATUS AND MUSICAL SOUND PROCESSING METHOD

(71) Applicant: Roland Corporation, Shizuoka (JP)

(72) Inventors: Tadashi Nakayama, Shizuoka (JP); Shohei Kubo, Shizuoka (JP)

(73) Assignee: Roland Corporation, Shizuoka (JP)

(21) Appl. No.: 18/658,959

(22) Filed: May 8, 2024

(30) Foreign Application Priority Data
Jun. 23, 2023 (JP) 2023-103480

(51) Int. Cl. G10H 7/00; G10H 1/04; G10H 1/08

(52) U.S. Cl. CPC G10H 7/008; G10H 1/04; G10H 1/08; G10H 2250/025; G10H 2250/305; G10H 2250/615

(57) ABSTRACT

A musical sound processing apparatus includes: a first generation part configured to generate a plurality of first signals in which at least one of a frequency characteristic and a time response of each of a plurality of processing unit signals obtained from a musical sound signal is modified; and a second generation part configured to generate a plurality of second signals in which at least one of a frequency characteristic and a time response of a noise signal associated with one or more of the plurality of processing unit signals is replaced with at least one of a frequency characteristic and a time response of the corresponding first signal.

### CROSS-REFERENCE TO RELATED APPLICATION

This application claims the priority benefits of Japanese application no. 2023-103480, filed on Jun. 23, 2023. The entirety of the above-mentioned patent application is hereby incorporated by reference herein and made a part of this specification.

### BACKGROUND

### Technical Field

The disclosure relates to a musical sound processing apparatus and a musical sound processing method.

### Description of Related Art

Conventionally, electronic sound processors use simulated impulse responses to create

reverberation effects. There is also a Schroeder type technique for providing reverb effects (see, for example, Non-Patent Document 1 (Natural Sounding Artificial Reverberation, M. R. SCHROEDR, Bell Telephone Laboratories, Incorporated, Murray Hill, New Jersey, JOURNAL OF THE AUDIO ENGINEERING SOCIETY, July 1962, VOLUME 10, NUMBER 3)).

The disclosure provides a musical sound processing apparatus and a musical sound processing method capable of generating a signal of sound effect suitable for a musical sound signal.

### SUMMARY

An embodiment of the disclosure provides a musical sound processing apparatus, which includes: a first generation part configured to generate a plurality of first signals in which at least one of a frequency characteristic and a time response of each of a plurality of processing unit signals obtained from a musical sound signal is modified; and a second generation part configured to generate a plurality of second signals in which at least one of a frequency characteristic and a time response of a noise signal associated with one or more of the plurality of processing unit signals is replaced with at least one of a frequency characteristic and a time response of the corresponding first signal.

An embodiment of the disclosure provides a musical sound processing method for an information processing apparatus to: generate a plurality of first signals in which at least one of a frequency characteristic and a time response of each of a plurality of processing unit signals obtained from a musical sound signal is modified; and generate a plurality of second signals in which at least one of a frequency characteristic and a time response of a noise signal associated with one or more first signals among the plurality of first signals is replaced with at least one of a frequency characteristic and a time response of the one or more first signals.

### BRIEF DESCRIPTION OF THE DRAWINGS

FIG. 1 shows an example of the configuration of the musical sound processing apparatus.

FIG. 2 is an explanatory diagram of the musical sound processing apparatus.

FIG. 3 is a flowchart showing an example of the processing of the musical sound processing apparatus shown in FIG. 2.

FIG. 4 is an explanatory diagram showing the first configuration example.

FIG. 5 is a diagram showing the first circuit configuration example applicable to the first configuration example.

FIG. 6 is a diagram showing the second circuit configuration example applicable to the first configuration example.

FIG. 7 is a flowchart showing an example of the processing in the first configuration example.

FIG. 8A to FIG. 8D are diagrams showing the correspondence relationships between the processing unit signal and the noise signal.

FIG. 9 is a diagram showing a modified example of the envelope.

FIG. 10A to FIG. 10D are diagrams showing modified examples of the envelope.

FIG. 11A is an explanatory diagram of ADSR, and FIG. 11B shows an example of waveform control parameters.

FIG. 12 is a diagram showing an example of the configuration of the musical sound processing apparatus having a convolution part.

FIG. 13 is an explanatory diagram of the convolution part.

FIG. 14 is an explanatory diagram of the convolution part.

FIG. 15 is an explanatory diagram of the convolution part.

FIG. 16 is an explanatory diagram of the convolution part.

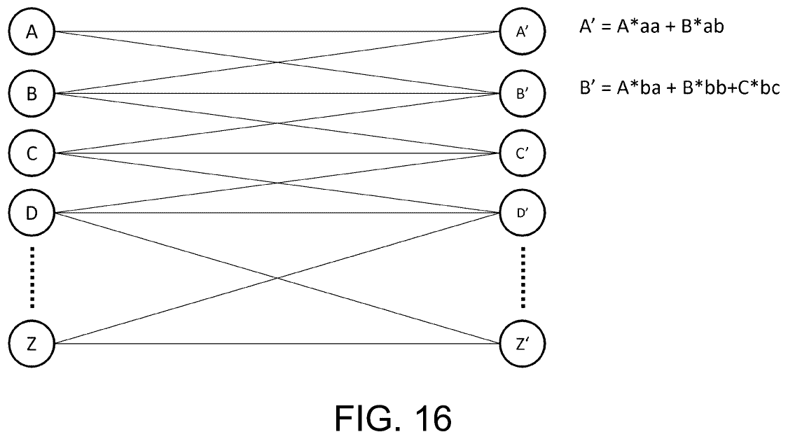

FIG. 17 is a diagram showing an example illustrating the operation of the convolution part.

FIG. 18 is an explanatory diagram showing the second configuration example.

FIG. 19 is a diagram showing a circuit configuration example applicable to the second configuration example.

FIG. 20 is a flowchart showing an example of the processing in the second configuration example.

### DESCRIPTION OF THE EMBODIMENTS

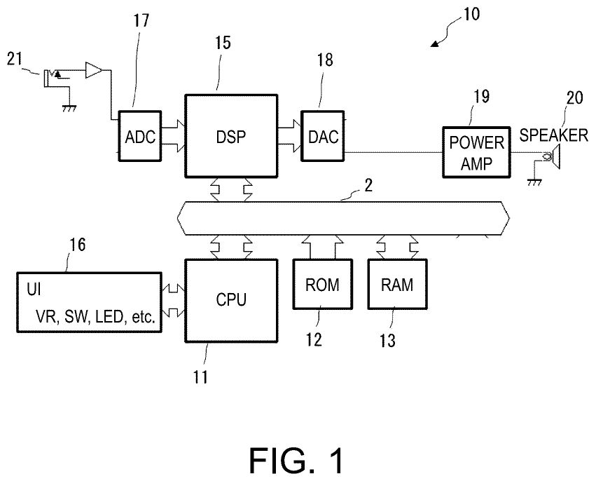

Hereinafter, a musical sound processing apparatus and a musical sound processing method according to the embodiments will be described with reference to the drawings. Nevertheless, the configurations of the embodiments are merely examples, and the disclosure is not limited to the configurations of the embodiments. FIG. 1 is a diagram showing an example of the circuit configuration of the musical sound processing apparatus (an information processing apparatus that operates as a musical sound processing apparatus) according to an embodiment. The musical sound processing apparatus is, for example, an apparatus called an effector, which generates a sound effect from a musical sound. However, the configuration according to the embodiment may be implemented in an apparatus other than an effector.

In FIG. 1, the musical sound processing apparatus 10 includes a CPU (Central Processing Unit) 11 configured to control the overall operation of the musical sound processing apparatus 10. The CPU 11 is connected to a ROM (Read Only Memory) 12, a RAM (Random Access Memory) 13, and a DSP (Digital Signal Processor) 15 via a bus 2. A user interface (UI) 16 is connected to the CPU 11.

The RAM 13 is used as a working area for the CPU 11 and a storage area for programs and data. The ROM 12 is used as a storage area for programs and data. The RAM 13 and the ROM 12 are examples of a storage device (storage medium). The CPU 11 is an example of a processor.

The musical sound processing apparatus 10 includes an input terminal 21 to which a musical sound is input. A musical sound signal is input to the terminal 21. The musical sound signal includes the sound of a musical instrument. The musical sound may include a human voice.

The musical sound signal input to the input terminal 21 is converted from analog to digital by an ADC (analog-to-digital converter) 17 and input to the DSP 15. The DSP 15 generates a signal of sound effect from the musical sound signal in digital form input from the ADC 17, and outputs a signal in which the musical sound signal and the signal of sound effect are added together. The musical sound signal output from the DSP 15 is input to a DAC (digital-to-analog converter) 18, converted into an analog signal, and input to a power amplifier 19. The power amplifier 19 amplifies the input signal and connects to a speaker 20. The speaker 20 emits a sound obtained by adding a sound effect to the musical sound signal.

The UI 16 includes an input device such as a dial, a switch, a button, and a key for inputting or setting a plurality of setting values (parameters) for the musical sound processing apparatus 10, and an indicator (lamp, LED, display, etc.) for displaying the state and settings of the musical sound processing apparatus 10.

The CPU 11 executes the programs stored in the storage device or the like to perform processing such as storing parameters related to the creation of sound effect set using the UI 16 in the storage device and setting the same in the DSP 15. The DSP 15 generates a signal of sound effect according to the parameters set by the CPU 11 by executing a program.

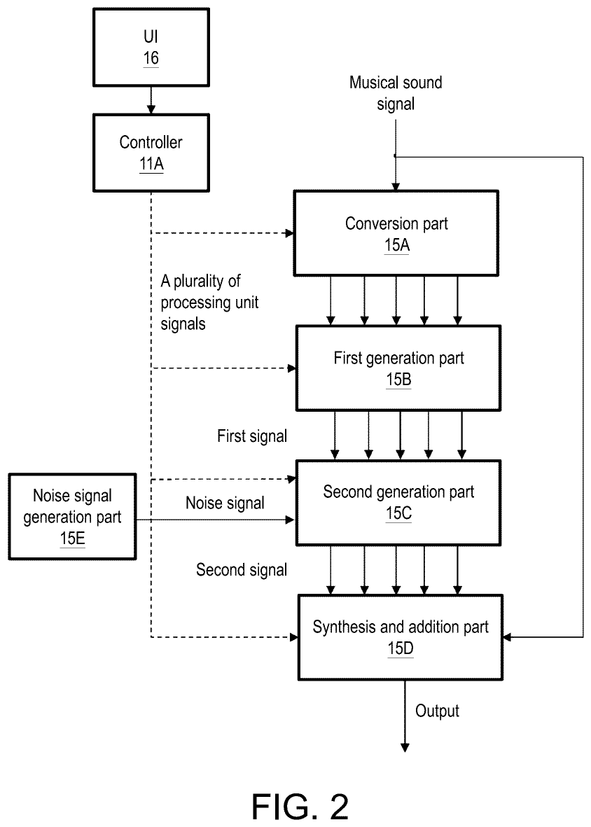

FIG. 2 is an explanatory diagram of the musical sound processing apparatus 10. By executing a program, the DSP 15 operates as a device that includes a conversion part 15A, a first generation part 15B, a second generation part 15C, a synthesis and addition part 15D, and a noise signal generation part 15E. Moreover, the CPU 11 operates as a controller 11A that controls the operation of the DSP 15 (15A to 15E) by executing a program.

The conversion part 15A generates a plurality of divided signals by dividing the input musical sound signal into a predetermined number of processing unit signals. The first generation part 15B generates a plurality of first signals by modifying at least one of the frequency characteristic and the time response of each of the plurality of processing unit signals input from the conversion part 15A.

The plurality of first signals (for each processing unit) and a noise signal are input to the second generation part 15C. The noise signal is generated by the noise signal generation part 15E. In this specification, the noise signal includes a signal whose waveform constantly changes. The noise signal includes a white noise signal (white noise) and a colored noise signal (pink noise, blue noise, etc.). Additionally, the noise signal may include a signal having characteristics of both a white noise signal and a colored noise signal. The noise signal may also include a band noise signal. The noise signal may also include a signal that includes at least one of a stationary irregular random signal and a random signal (random number) based on a pseudorandom number sequence. Further, the noise signal may include a signal whose waveform on a time axis changes over time but whose ratio of each frequency component is constant. The noise signal may also include a signal that is a non-attenuating signal and is semi-permanently sustainable, or a signal that always has a constant power.

The second generation part 15C generates second signals by replacing at least one of the frequency characteristic and the time response of the noise signal associated with one or more first signals among the plurality of first signals with at least one of the frequency characteristic and the time response of the one or more first signals.

The synthesis and addition part 15D outputs a signal by adding the musical sound signal to a signal obtained by synthesizing the plurality of second signals generated by the second generation part 15C. The synthesis and addition part 15D may be composed of a synthesis part that synthesizes the second signals, and an addition part that adds the musical sound signal to the signal generated by the synthesis part. Nevertheless, the synthesis part and the addition part are optional and are not necessarily essential components.

The noise signal generation part 15E is capable of generating a plurality of noise signals that can be associated with the plurality of processing unit signals (first signals).

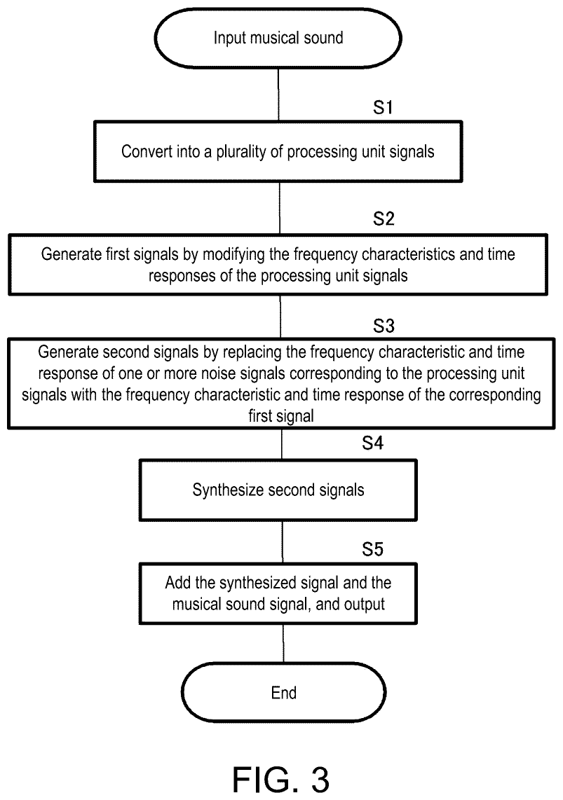

FIG. 3 is a flowchart showing an example of the processing of the musical sound processing apparatus shown in FIG. 2. In step S1, the conversion part 15A converts a musical sound signal into a plurality of processing unit signals. In step S2, the first generation part 15B generates first signals by modifying the frequency characteristics and the time responses of the processing unit signals.

In step S3, the second generation part 15C generates second signals by replacing the frequency characteristic and the time response of one or more noise signals corresponding to the processing unit signals with the frequency characteristic and the time response of the corresponding first signal.

In step S4, the synthesis and addition part 15D synthesizes the second signals, adds the musical sound signal to the synthesized signal (signal of sound effect), and outputs the result (step S5). Thereby, the musical sound signal and the sound effect are emitted.

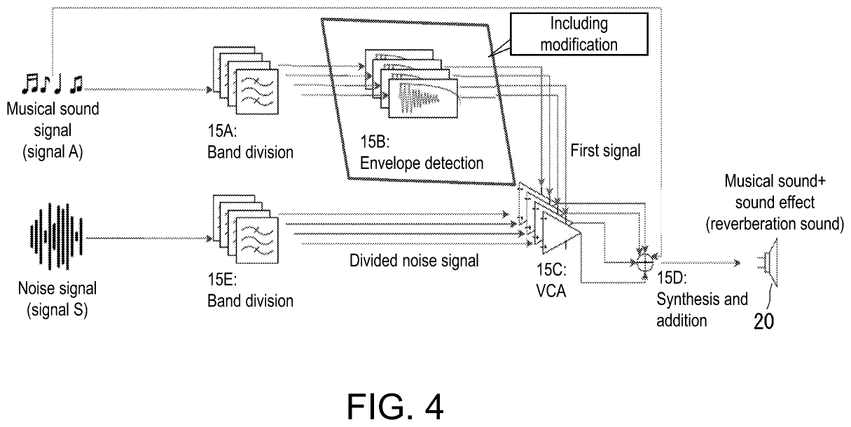

FIG. 4 is an explanatory diagram showing the first configuration example. In the following description, the musical sound signal may be referred to as “signal A” and the noise signal may be referred to as “signal S.” In the first configuration example, the conversion part 15A includes a plurality of band pass filters (BPFs). The conversion part 15A performs band division on the input musical sound signal using the plurality of BPFs, and converts (separates) the musical sound signal into a plurality of band signals (a plurality of divided signals). The plurality of divided signals correspond to a plurality of processing unit signals.

Further, the first generation part 15B detects an envelope of amplitude with respect to each of the plurality of band signals, and performs processing to modify the envelope. The envelope includes at least one of the frequency characteristic and the time response of the signal. For example, the first generation part 15B includes an envelope generator, and is capable of controlling Attack (rise), Decay (attenuation), Sustain (retention after attenuation), and Release (lingering sound) of the envelope. For example, in the case of generating a reverberation sound (reverb) as the sound effect, the first generation part 15B lengthens the time of release (lingering sound) of the envelope. The signal that has undergone such envelope detection and modification processing is the first signal. The envelope modification processing is not necessarily performed on all the divided signals, but is performed on one or more bands that require control.

The noise signal generation part 15E includes a plurality of BPFs. A single noise signal input to the noise signal generation part 15E is converted into divided noise signals of a plurality of bands. The divided bandwidth and the number of bands may be the same as or different from the number of bands and bandwidth for the musical sound signal.

The second generation part 15C includes a plurality of voltage controlled amplifiers (VCAs). The noise divided signal is input to each VCA as an input signal. Further, the first signal having a correspondence relationship with the noise divided signal is input to each VCA as a control signal. Thereby, the gain (magnitude) of the amplification of the noise divided signal is controlled by the magnitude of the first signal. That is, at least one of the frequency characteristic and the time response of the noise divided signal is replaced with at least one of the frequency characteristic and the time response of the corresponding first signal.

The output signal from each VCA is synthesized in the synthesis and addition part 15D. The synthesis and addition part 15D adds the original musical sound signal to the synthesized signal, and outputs the result. Thereby, a sound with a reverberation sound (sound effect) added to the musical sound signal is emitted from the speaker 20.

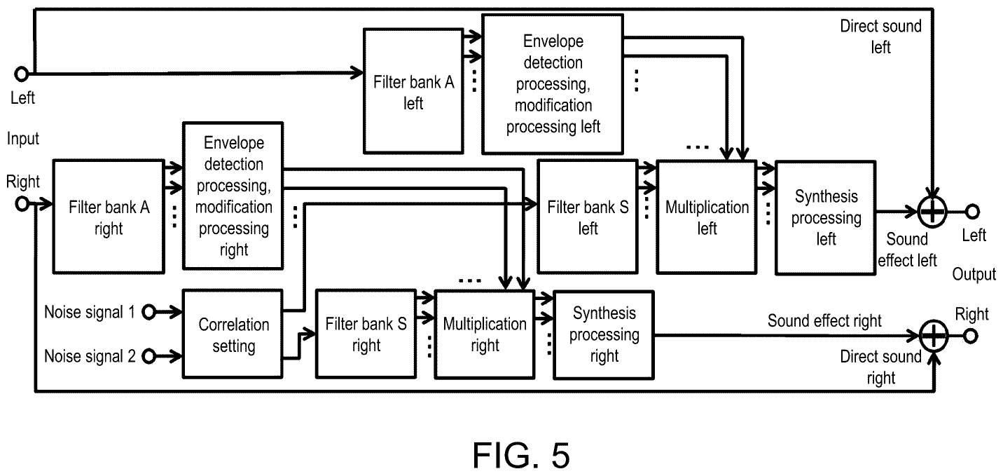

FIG. 5 is a diagram showing the first circuit configuration example applicable to the first configuration example. FIG. 5 shows an example of the circuit configuration of a musical sound processing apparatus that performs the operation shown in FIG. 4 on left and right musical sound signals. In FIG. 5, the circuit includes a series for the musical sound signal on the left side and a series for the musical sound signal on the right side. Both have the same configuration.

“Filter bank A left” and “filter bank A right” respectively correspond to the left and right conversion parts 15A, and convert the input musical sound signals into the above-mentioned plurality of divided signals using a plurality of BPFs. “Envelope detection processing, modification processing left” and “envelope detection processing, modification processing right” correspond to the left and right first generation parts 15B, and detect the envelope for each input divided signal and perform necessary envelope modification to generate a plurality of first signals.

“Correlation setting,” “filter bank S left,” and “filter bank S right” correspond to the left and right noise signal generation parts 15E. “Correlation setting” sets the correlation (degree of difference) between two noise signals (noise signal 1, noise signal 2). Noise signal 1 with correlation set by “correlation setting” is input to “filter bank S left”, and noise signal 2 is input to “filter bank S right.” Each of the “filter bank S left” and “filter bank S right” converts the input noise signal into a predetermined number of noise divided signals.

“Multiplication left” and “multiplication right” correspond to the left and right second generation parts 15C, and operate as VCAs for each noise divided signal input from the corresponding filter bank. “Synthesis processing left” and “synthesis processing right” correspond to the left and right synthesis parts, and generate signals by synthesizing a plurality of second signals input thereto. The left and right addition parts add the synthesized signals output from the corresponding synthesis parts and the original musical sound signals (direct sounds) and output the results. Thereby, left and right musical sound signals and sound effects (for example, reverberation sounds) are emitted from the left and right speakers.

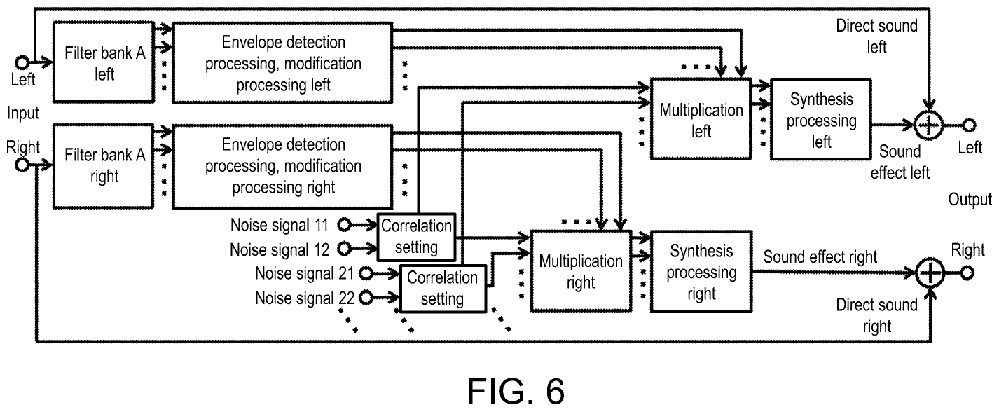

FIG. 6 is a diagram showing the second circuit configuration example applicable to the first configuration example. In the first circuit configuration example, one noise signal respectively for the left and right is divided to obtain a plurality of noise divided signals. In contrast, in the second circuit configuration example, a plurality of noise signals (noise signal 11, noise signal 21, noise signal 31, . . . ) corresponding to the noise divided signal on the left side are prepared, and a plurality of noise signals (noise signal 12, noise signal 22, noise signal 32, . . . ) corresponding to the noise divided signal on the right side are prepared. After the correlation is set, the plurality of noise signals are input to “multiplication left” or “multiplication right” as input signals for the VCA. Except for this point, the second circuit configuration example is the same as the first circuit configuration example. The number of the input terminals and the number of the output terminals may be two or more.

The circuits shown in FIG. 5 and FIG. 6 may be actual circuits (hardware), but in this embodiment, the DSP 15 operates as the circuits shown in FIG. 5 or FIG. 6 in accordance with a program. Moreover, the above-mentioned VCA may be replaced by a device other than a VCA, as long as the gain can be controlled in response to a control signal. For example, a gain control device or DSP control can be applied. In the circuit configuration examples shown in FIG. 5 and FIG. 6, the musical sound signal may be a musical sound signal input from the terminal 21 or a musical sound signal reproduced within the musical sound processing apparatus 10. In addition, a musical sound signal that has been divided into each band in advance may be reproduced. Thus, band division is not necessarily essential. Furthermore, the noise signal may be generated inside the musical sound processing apparatus 10 using a noise generator or the like, or may be input from outside the musical sound processing apparatus 10 using an input terminal of the musical sound processing apparatus 10.

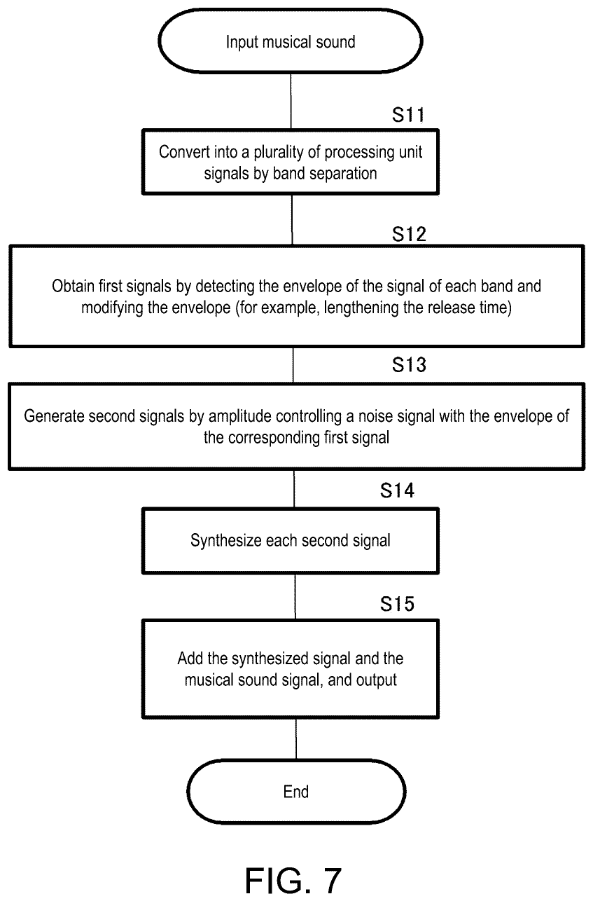

FIG. 7 is a flowchart showing an example of the processing in the first configuration example. In step S11, “filter bank A left” and “filter bank A right” respectively perform conversion into a plurality of processing unit signals (separation into a plurality of divided signals) by band separation.

In step S12, “envelope detection processing, modification processing left” and “envelope detection processing, modification processing right” respectively obtain first signals by detecting the envelope of the divided signal of each band and modifying the envelope (for example, lengthening the release time).

In step S13, “multiplication left” and “multiplication right” respectively generate second signals by amplitude controlling a noise signal with the envelope of the corresponding first signal. In step S14, a plurality of second signals are synthesized by the synthesis part. In step S15, the addition part adds the synthesized signal and the musical sound signal and outputs the result.

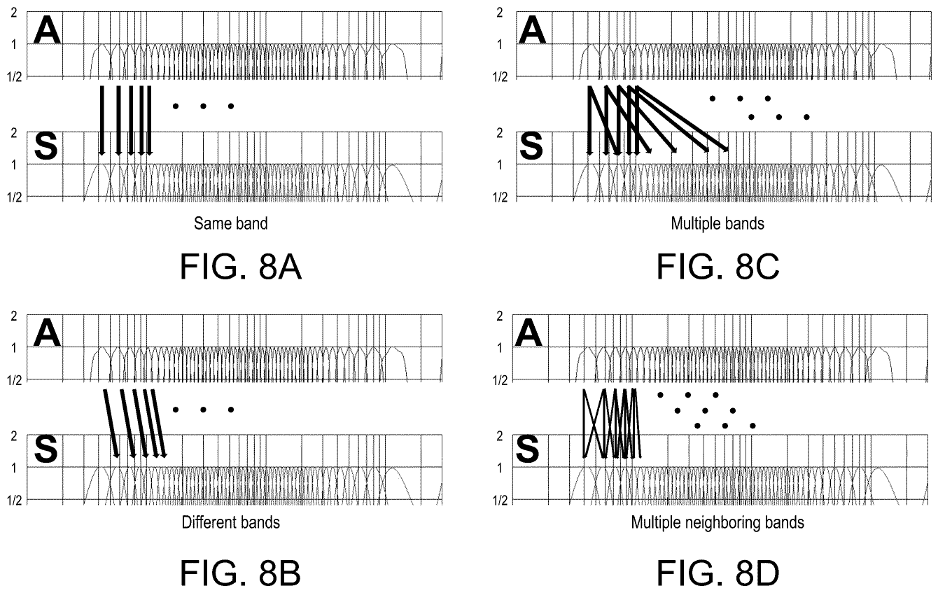

FIG. 8A to FIG. 8D are diagrams showing the correspondence relationships between the processing unit signal and the noise signal. For example, the musical sound signal (signal A) and the noise signal (signal S) may be associated with each other in the same band, and envelope replacement may be performed for the same band (FIG. 8A). Bands of signal A may be associated with different bands of signal S (FIG. 8B). Also, signal A and signal S may be associated at a 1:1 ratio, and as shown in FIG. 8C, the bands of the musical sound signal and the bands of the noise signal may be associated at a 1:n ratio (n is a natural number of 2 or more).

Furthermore, as shown in FIG. 8D, the bands of the musical sound signal and the bands of the noise signal may be associated at an n:n ratio (n is a natural number of 2 or more). In other words, the envelope of one or more first signals can be used to control the envelope of one or more noise signals.

In the case of controlling multiple bands of a noise signal, by controlling the same band as the musical sound signal and the band one octave above or below, an effect called Shimmer Reverb can be produced. Furthermore, by controlling the same band as the musical sound signal and the bands before and after (on both sides of) that band at the same timing, the side bands can be increased. Also, the envelope of the noise signal may be controlled using a band division set of a musical sound signal that is completely different from the band division set of the noise signal.

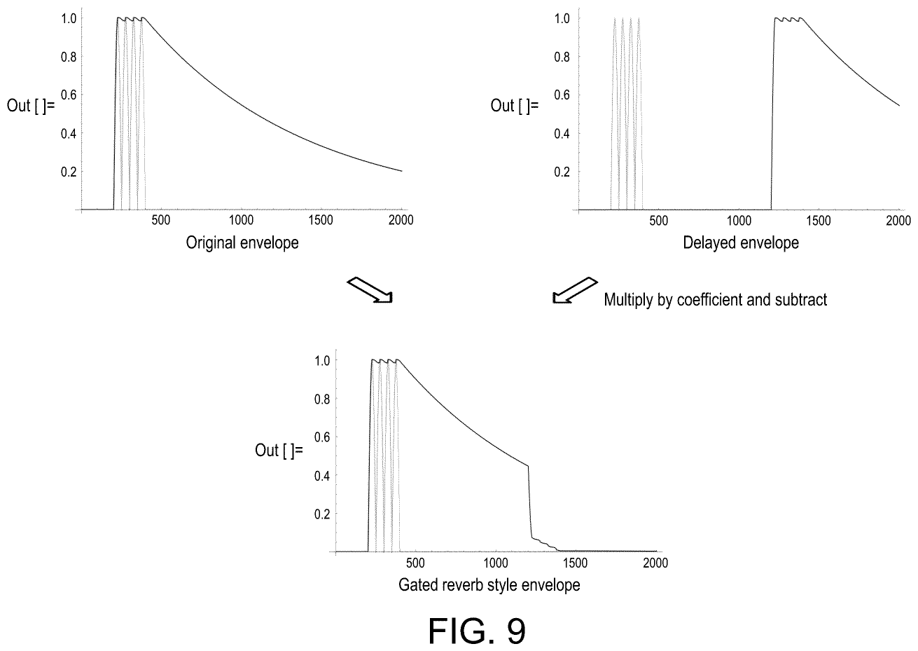

FIG. 9 is a diagram showing a modified example of the envelope. In the case where the upper left envelope is the original envelope of the musical sound signal, a delayed envelope can be generated as shown on the right side. At this time, by subtracting the delayed envelope multiplied by a coefficient from the original envelope, a gated reverb style envelope (acoustic effect) can be obtained. That is, by taking advantage of the fact that the attenuation characteristics of the release are similar no matter which part is cut out, and delaying the detected envelope of the musical sound signal, multiplying by a coefficient, and subtracting the result, the value of the envelope can be set to 0 after the delay time. With the settings changed depending on the band, it is possible to obtain a reverberation sound that was previously unavailable. Since the conventional gated reverb is operated by detecting the input threshold, it can only be applied to a single musical instrument sound. In contrast thereto, in the method according to the embodiment, even if a plurality of musical instrument sounds are input, each processing unit operates individually, so a natural effect can be obtained. Furthermore, if the gate time is shortened so that it is not perceptible as a reverberation sound, it is possible to obtain a previously unknown tone.

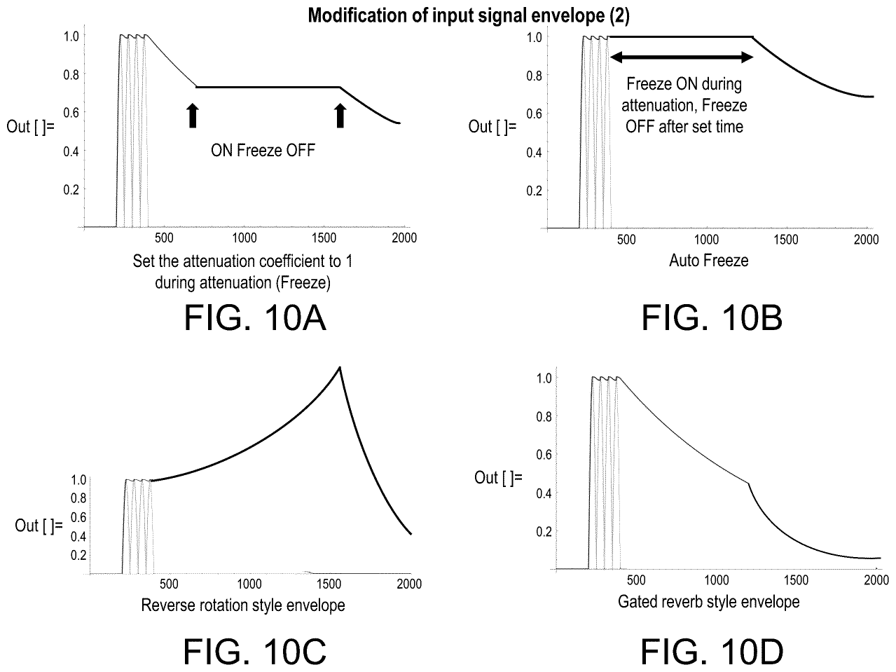

FIG. 10A to FIG. 10D are diagrams showing modified examples of the envelope. As shown in FIG. 10A, if the attenuation coefficient when detecting the envelope of the input signal (musical sound signal) is set to 1 (freeze on), the reverberation sound at that point can be frozen (the level at that point is maintained until freeze is turned off).

Further, as shown in FIG. 10B, if a time count is started during attenuation and the attenuation coefficient is set to 1 until the counted value reaches a count value indicating the set time, an automatic freeze effect can be obtained.

Furthermore, if the attenuation coefficient during the freeze operation is set to be slightly greater than 1, a reverse rotation style reverberation sound is obtained (see FIG. 10C). Moreover, if the attenuation coefficient during the freeze operation is set to be less than 1, a gated reverb style effect can be obtained (see FIG. 10D). In addition, by controlling the attenuation coefficient, it is possible to perform two-stage attenuation in which, for example, the envelope attenuates at a predetermined rate (slope) from the start of counting until a predetermined count value is reached, and the attenuation slows down (or speeds up) when the predetermined count value is reached.

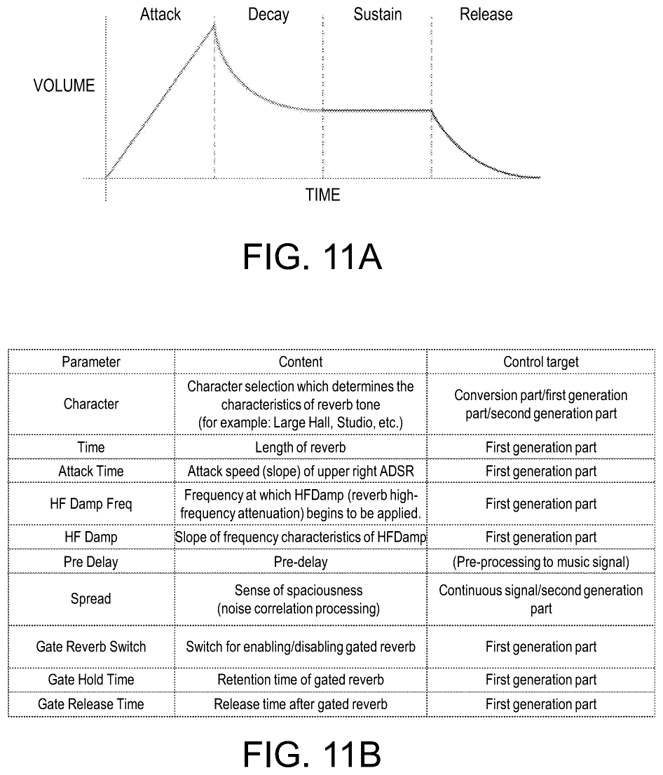

If the envelope modification and the freeze operation are combined, a time change such as ADSR can be created. FIG. 11A is an explanatory diagram of ADSR, and FIG. 11B shows an example of waveform control parameters. As shown in FIG. 11A, Attack is a parameter that sets the time it takes to reach the amplitude when the input amplitude increases. If the time is set to 0 second, the input amplitude is immediate. Decay (attenuation) is a parameter that sets the time it takes to transition from the amplitude reached in Attack to Sustain. Sustain (retention after attenuation) is a parameter that sets the time for which the level is maintained. Release (lingering sound) is a parameter that sets the time from the end of Sustain to the end of the sound.

As shown in the table of FIG. 11B, in the case where the effect is a reverberation sound (reverb), the parameters set by the controller 11A (CPU 11) in the DSP 15 may include character selection which determines the characteristics of the reverb tone, the reverb length, the attack speed, the frequency at which reverb high-frequency attenuation begins to be applied, etc. The parameters may also include parameters related to gated reverb, such as a switch for enabling/disabling gated reverb. Such parameters are preset before the input of the musical sound signal.

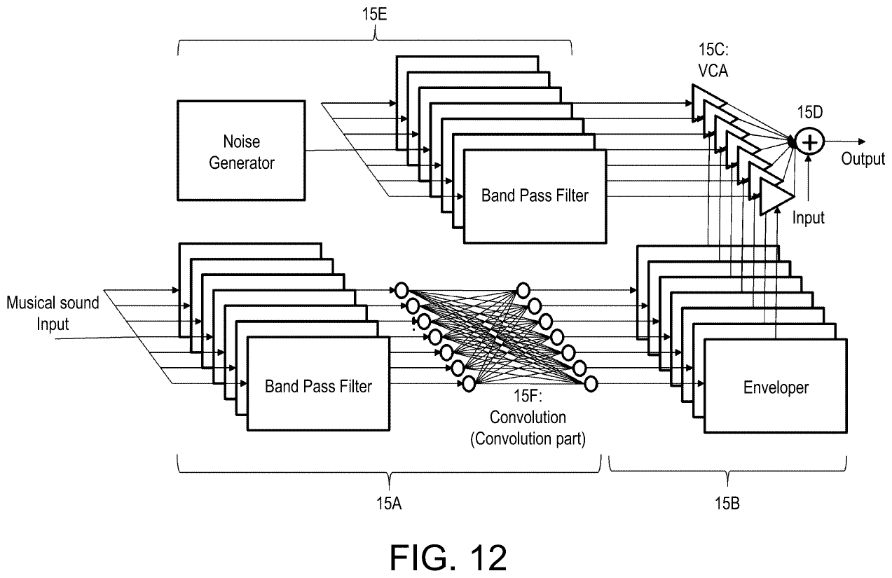

FIG. 12 is a diagram showing an example of the configuration of a musical sound processing apparatus that includes a convolution part for setting the correspondence relationship between a processing unit signal and a noise signal. In the example shown in FIG. 12, the conversion part 15A of the musical sound processing apparatus includes a plurality of BPFs and a convolution part (convolution) 15F. The first generation part 15B includes an enveloper that detects the envelope of the amplitude of a musical sound signal and performs necessary modification. However, the convolution part 15F may be a part of the first generation part 15B, or may be configured independent of the conversion part 15A and the first generation part 15B.

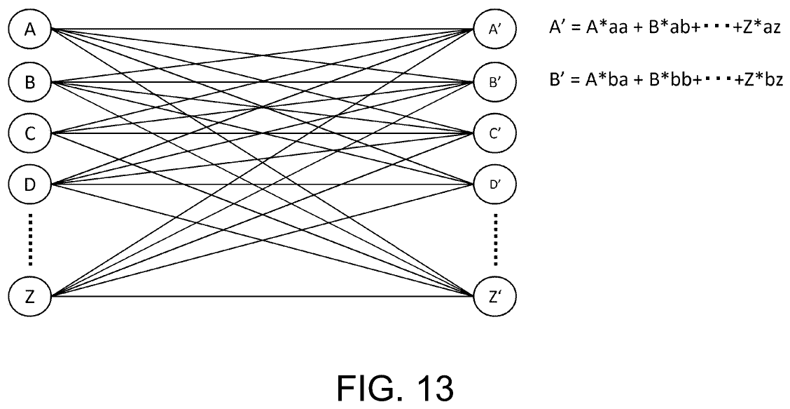

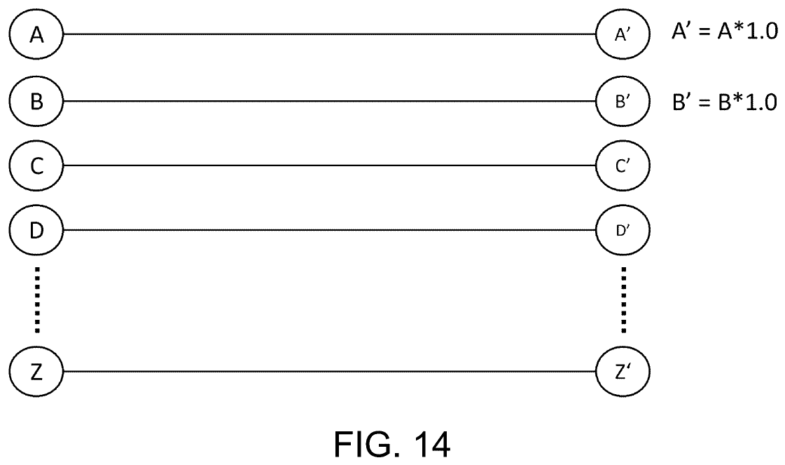

As shown in FIG. 13, the convolution part 15F includes a plurality of input terminals and a plurality of output terminals, and the plurality of input terminals and the plurality of output terminals are fully connected (all elements are convoluted). In FIG. 13, the illustration of the multiplier is omitted. By setting the coefficient (weight) for unused taps among the multiple taps extending from the input terminals to 0, as shown in FIG. 14, it is possible to set up a state in which each input terminal and each output terminal are connected 1:1, that is, a state in which no convolution is performed (in fact, the convolution part 15 does not exist).

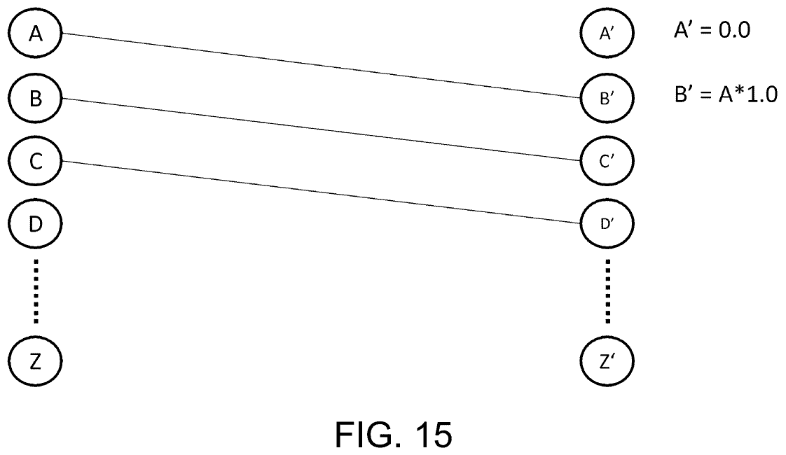

Furthermore, by setting the coefficient for the tap to 0, the band can be shifted to a desired output terminal, as shown in FIG. 15. Such a shift configuration can also be applied to an octave shift (changing the position of the octave up or down).

In addition, the peak can be emphasized by performing convolution such that the input terminals at both ends have two taps and each input terminal between the two ends is combined with three taps (the corresponding output terminal and taps on both sides).

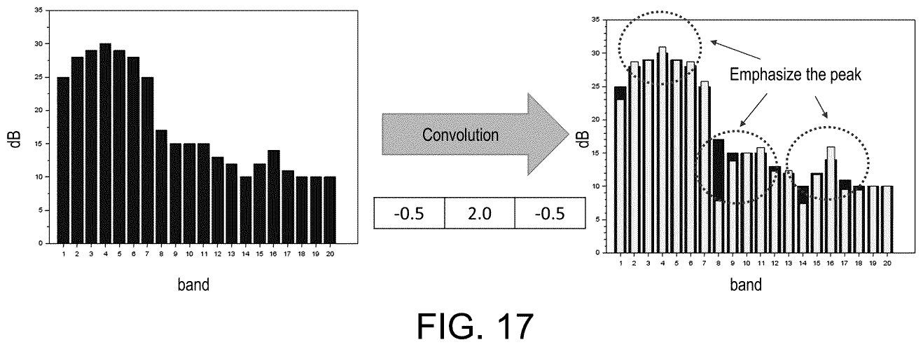

The graph on the left side of FIG. 17 is a graph showing each band (BPF) and the power of each band. The envelopes of each band and the adjacent bands on both sides were correlated (−0.5, 2.0, −0.5 in FIG. 17), and convolution was performed. The graph on the right side shows the result of the convolution. The convolution emphasizes the peak, giving the output result more definition. In the example shown in FIG. 17, at both ends of the band (numbers 1 and 20), the result from one side was used.

By providing the convolution part 15F in this way, it becomes possible to create tones. Moreover, a state where the convolution part 15F does not exist can be achieved by a simple operation of changing the coefficient.

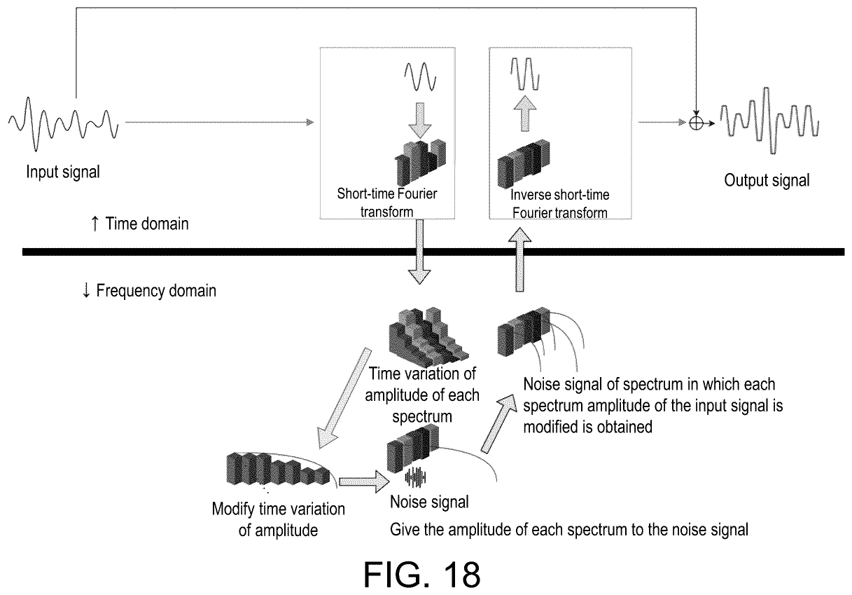

FIG. 18 is an explanatory diagram showing the second configuration example of the musical sound processing apparatus 10. In the second configuration example, the input signal (musical sound signal) is converted into a time variation of a frequency domain signal by short-time Fourier transform. That is, the signal is divided into frames according to a predetermined window size by window function processing, and Fourier transform (FFT, time-frequency transform) is performed on each frame, converting each frame from a time domain signal into a frequency domain signal. In this way, multiple frequency domain signals that are time variations are obtained.

By arranging the divided frames in order, the time variation of each spectrum is observed. Then, the amplitude in each spectrum (band) is detected for each frame, and necessary modification is applied to the time variation of the detected amplitude of each spectrum. The amplitude of each spectrum (band) is given to white noise (an example of the noise signal). This generates white noise with the amplitude of each spectrum being modified. That is, the source of the sound is white noise, and a spectrum is generated according to the amplitude that has been modified with respect to the musical sound signal. It is not necessarily essential that the amplitude modification be performed on all the spectra. It suffices if the amplitude modification is performed in regard to one or more desired spectra among a plurality of spectra.

All white noise having such a spectrum is converted into a time domain signal by inverse short-time Fourier transform. That is, inverse Fourier transform (IFFT) is performed to generate a time domain signal in units of frames. These time domain signals are synthesized according to an output window function. Then, the original input signal (musical sound signal) is added to the synthesized signal, and the result is output as an output signal.

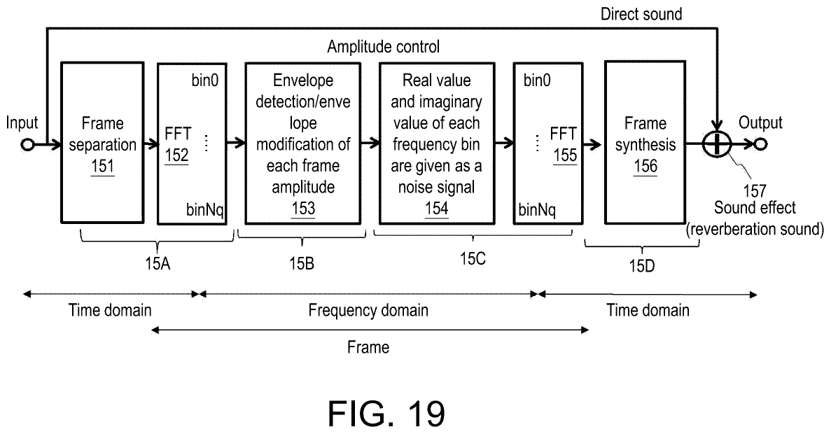

FIG. 19 is a diagram showing a circuit configuration example applicable to the second example configuration. In FIG. 19, “frame separation/window processing” (frame separation part 151) and “FFT” (FFT part 152) correspond to the conversion part 15A. Moreover, “envelope detection/envelope modification of each frame amplitude” (envelope detection part 153) shown in FIG. 19 corresponds to the first generation part 15B. Further, “real value and imaginary value of each frequency bin are given as a noise signal (for example, white noise)” (processing part 154) and “IFFT” (IFFT part 155) correspond to the second generation part 15C. “Window processing/frame synthesis” (synthesis part 156) and the adder 157 correspond to the synthesis and addition part 15D.

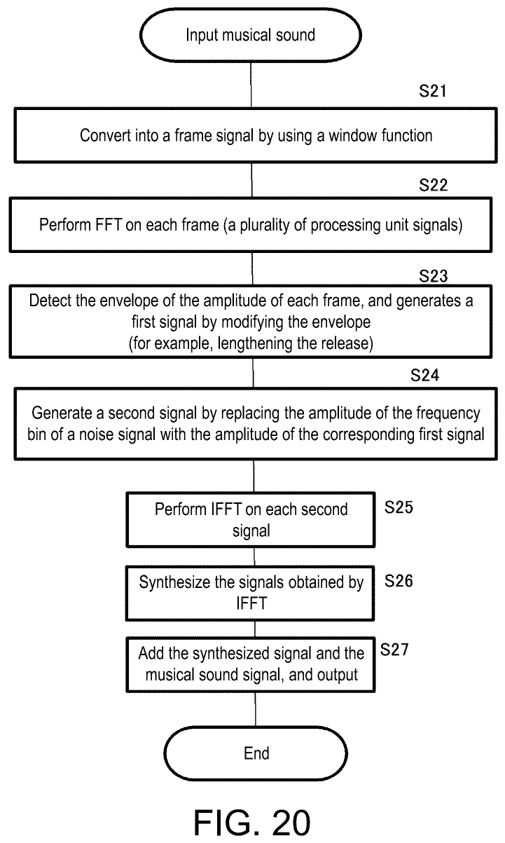

FIG. 20 is a flowchart showing an example of the processing in the second configuration example. In step S21, the frame separation part 151 converts the musical sound signal, which is an input signal, into a frame signal by using a window function.

In step S22, the FFT part 152 performs FFT on each frame, and converts the same into a plurality of processing units. In step S23, the envelope detection part 153 detects the envelope of the amplitude of each frame, and generates a first signal by modifying the envelope (for example, lengthening the release).

In step S24, the processing part 154 generates a second signal by replacing the amplitude of the frequency bin of a noise signal (for example, white noise) with the amplitude of the corresponding first signal. In step S25, the IFFT part 155 performs IFFT on each second signal. In step S26, the frame synthesis part 156 synthesizes the signals obtained by IFFT using an output window (window function). In step S27, the adder 157 adds the synthesized signal and the original musical sound signal and outputs the result.

In the above embodiment, a musical sound is used, but a natural sound may also be used. In addition, in the embodiment, a band pass filter bank or FFT is shown as the conversion part, but other systems may also be used. For example, “wavelet analysis” or “mode analysis” may be used. Further, the first generation part generates all of the amplitudes ADSR, but the first generation part may also generate any one of A, D, S, and R. A combination of multiple ADSRs may be used to generate complex waveform outlines.

According to the musical sound processing apparatus 10 of the embodiment, in either the first or second configuration example, the second signals are generated by replacing the envelope of the noise signal with the envelope of the musical sound signal that has been modified. The signal obtained by synthesizing the second signals is then added to the original musical sound signal and output. In this way, the desired sound effect is obtained.

Further, as an example of a sound effect, a suitable reverberation sound of a musical sound signal can be generated. An actual reverberation sound is the result of subtle air fluctuations (modulation of sound speed) in a three-dimensional space being superimposed on the sound reflected from wall surfaces, etc., causing sideband waves with temporal statistical behavior. The existing methods for generating a reverberation sound either ignore the above-mentioned fluctuation elements or reproduce a reverberation sound using only the characteristics of a single moment. For this reason, even if additional fluctuations are added to the reproduced reverberation sound, only monotonic sideband waves are obtained.

According to the musical sound processing apparatus 10, in the configuration described above, a signal is output by synthesizing second signals in which the envelope of the musical sound signal with a lengthened release (lingering sound) is replaced with the envelope of a noise signal, so it is possible to output a more suitable reverberation sound than before. The signal obtained by synthesizing the second signals may be output alone (in a state of being separated from the musical sound signal).

In the existing reverberation sound, a so-called crackling sound that can easily be a problem does not occur in principle. By independently setting the level of each band, and the attack time and release time when detecting the envelope of the input signal, a wide range of sounds can be created and easily modified. Therefore, it is easy to realize tones that were previously difficult to generate.

In the existing methods, the same input signal always results in the same output signal. In contrast thereto, in the musical sound processing apparatus 10 according to the embodiment, the waveform of the noise signal constantly changes, so even when the same input signal is input, the output signal is different as the noise signal changes. The configurations of the embodiments can be combined as appropriate without departing from the scope of the 10 disclosure.

What is claimed is:

1. A musical sound processing apparatus, comprising:
a first generation part configured to generate a plurality of first signals in which at least one of a frequency characteristic and a time response of each of a plurality of processing unit signals obtained from a musical sound signal is modified; and
a second generation part configured to generate a plurality of second signals in which at least one of a frequency characteristic and a time response of a noise signal associated with one or more first signals among the plurality of first signals is replaced with at least one of a frequency characteristic and a time response of the one or more first signals.

2. The musical sound processing apparatus according to claim 1, further comprising a synthesis part configured to synthesize the plurality of second signals generated by the second generation part.

3. The musical sound processing apparatus according to claim 2, further comprising an addition part configured to output a signal obtained by adding the musical sound signal to a signal synthesized by the synthesis part.

4. The musical sound processing apparatus according to claim 1, wherein the noise signal is one or more selected from a white noise signal, a colored noise signal, a signal having characteristics of both a white noise signal and a colored noise signal, and a band noise signal.

5. The musical sound processing apparatus according to claim 1, wherein the noise signal comprises a signal comprising at least one of a stationary irregular random signal and a random signal based on a pseudorandom number sequence.

6. The musical sound processing apparatus according to claim 1, wherein the noise signal comprises a signal whose waveform on a time axis changes over time but whose ratio of each frequency component is constant.

7. The musical sound processing apparatus according to claim 1, wherein the noise signal comprises a signal that is a non-attenuating signal and is semi-permanently sustainable.

8. The musical sound processing apparatus according to claim 1, wherein the plurality of processing unit signals are a plurality of divided signals obtained by dividing the musical sound signal into bands, and
the noise signal is a plurality of noise signals capable of being associated with one or more of the plurality of divided signals.

9. The musical sound processing apparatus according to claim 1, wherein the plurality of processing unit signals are a plurality of frequency domain signals obtained by dividing the musical sound signal according to a window size and performing time-frequency transform of divided signals, and
the noise signal is a plurality of noise signals capable of being associated with one or more of the plurality of frequency domain signals.

10. The musical sound processing apparatus according to claim 1, wherein the first generation part modifies an envelope of each of the plurality of processing unit signals.

11. The musical sound processing apparatus according to claim 10, wherein the first generation part lengthens a release time of the envelope of the processing unit signal.

12. The musical sound processing apparatus according to claim 1, wherein the first generation part performs convolution processing on the plurality of processing unit signals.

13. A musical sound processing method, for an information processing apparatus to:
generate a plurality of first signals in which at least one of a frequency characteristic and a time response of each of a plurality of processing unit signals obtained from a musical sound signal is modified; and
generate a plurality of second signals in which at least one of a frequency characteristic and a time response of a noise signal associated with one or more first signals among the plurality of first signals is replaced with at least one of a frequency characteristic and a time response of the one or more first signals.

14. The musical sound processing method according to claim 13, wherein the information processing apparatus is further configured to synthesize the generated plurality of second signals.

15. The musical sound processing method according to claim 14, wherein the information processing apparatus is further configured to output a signal obtained by adding the musical sound signal to a synthesized signal.

16. The musical sound processing method according to claim 13, wherein the plurality of processing unit signals are a plurality of divided signals obtained by dividing the musical sound signal into bands, and
the noise signal is a plurality of noise signals capable of being associated with one or more of the plurality of divided signals.

17. The musical sound processing method according to claim 13, wherein the plurality of processing unit signals are a plurality of frequency domain signals obtained by dividing the musical sound signal according to a window size and performing time-frequency transform of divided signals, and
the noise signal is a plurality of noise signals capable of being associated with one or more of the plurality of frequency domain signals.

18. The musical sound processing method according to claim 13, wherein the information processing apparatus is configured to modify an envelope of each of the plurality of processing unit signals.

19. The musical sound processing method according to claim 18, wherein the information processing apparatus is configured to lengthen a release time of the envelope of the processing unit signal.

20. A non-transitory computer readable medium, storing a program being executed by a computer and causing the computer to execute:
generating a plurality of first signals in which at least one of a frequency characteristic and a time response of each of a plurality of processing unit signals obtained from a musical sound signal is modified; and
generating a plurality of second signals in which at least one of a frequency characteristic and a time response of a noise signal associated with one or more first signals among the plurality of first signals is replaced with at least one of a frequency characteristic and a time response of the one or more first signals.
